(19) United States
(12) Patent Application Publication
(10) Pub. No.: US 2009/0029043 A1
(43) Pub. Date: Jan. 29, 2009

(54) Multifunctional star-shaped prepolymers, their preparation and use

(76) Inventors: Haitao RONG, Darmstadt (DE); Jurgen GROLL, Aachen (DE); Peter GREIWE, Heidelberg (DE); Gallus SCHECHNER, Seefeld (DE); Christine MOHR, Ober-Ramstadt (DE); Martin MOLLER, Aachen (DE)

Correspondence Address: PAUL & PAUL, 2000 MARKET STREET, Suite 2900, PHILADELPHIA, PA, 19103-3229, US

(21) Appl. No.: 12/194,834

(22) Filed: Aug. 20, 2008

Related U.S. Application Data
(63) Continuation of application No. PCT/EP2007/001056, filed on Feb. 8, 2007.

(30) Foreign Application Priority Data
Feb. 23, 2006 (DE) 10 2006 009 004.7

(51) Int. Cl. B05D 1/12; B05D 3/02; B05D 3/12; C08G 77/14; C08G 77/26; C08L 83/06

(52) U.S. Cl. 427/180; 427/387; 427/240; 528/29; 525/474; 528/28; 525/418; 525/452; 528/27; 528/26; 525/479; 524/588

(57) ABSTRACT

The present invention relates to coatings that possess a dynamic contact angle hysteresis in water, measured by means of a Wilhelmy balance according to DIN EN 14370, of at most 15°, and are can be manufactured from star-shaped prepolymers and/or star-shaped prepolymer-nanoparticle complexes that are cross-linkable with one another and with the surface of the substrate to be coated, the star-shaped prepolymers and/or star-shaped prepolymer-nanoparticle complexes possessing, before being cross-linked, at least three hydrophilic polymer arms that, considered of themselves, are soluble in water, and that carry on all or on some of their free ends R¹ silyl terminal groups of the following general formula (I): R¹ is —CR^{a}₂—Si(OR^{b})ᵣ(R^{c})₃₋ᵣ, where R^{a} denotes hydrogen or a linear or branched alkyl group having 1 to 6 carbon atoms, OR^{b} denotes a hydrolyzable group, R^{c} denotes a linear or branched alkyl group having 1 to 6 carbon atoms, and r denotes a number from 1 to 3, and that carry, on the optionally present ends not carrying silyl terminal groups, reactive groups that are reactive with respect to themselves, the substrate to be coated, entities optionally introduced into the coating, and/or with the silyl terminal groups. The present invention furthermore relates to a method for manufacturing such coatings, and to star-shaped prepolymers that are used in the coatings. The invention moreover relates to use of the star-shaped prepolymers as additives to various agents for temporary or permanent anti-soiling finishing of surfaces.

### CROSS-REFERENCE TO RELATED APPLICATIONS

This application is a continuation under 35 U.S.C. Sections 365(c) and 35 U.S.C. Section 120 of International Application No. PCT/EP2007/001056, filed Feb. 8, 2007. This application also claims priority under 35 U.S.C. Section 119 of German Patent Application No. DE 10 2006 009 004.7, filed February 23, 2006.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to coatings on the basis of mutually cross-linkable star-shaped prepolymers and/or star-shaped prepolymer-nanoparticle complexes having hydrophilic polymer arms that carry hydrolyzable silyl and/or siloxyl terminal groups at their free ends, and to the manufacture of coatings based thereon. The invention further relates to the star-shaped prepolymers suitable for such coatings, and to their manufacture and use in a multiplicity of fields of application.

In a variety of fields of application such as, for example, medicine, bioanalysis, cosmetics, in technical equipment, textile finishing, laundry detergents for textiles, the household sector, the hygiene sector, and the area of anti-fouling, a requirement exists for finishing surfaces so that, in particular, they repel dirt and microbial contaminants, whether proteins or cells (soil repellency), and to facilitate the release thereof and ability to wash them out (soil release). Because dirt, protein, various polymers, or cells, in particular, usually adhere well to hydrophobic materials, a particular need exists for hydrophilically equipped surfaces.

(2) Description of Related Art, Including Information Disclosed Under 37 C.F.R. Sections 1.97 and 1.98

Among the hydrophilic coatings that have hitherto been most effective are hydrogel coatings based on polyethylene oxides or polyethylene glycols. A variety of methods are proposed for manufacturing such coatings.

WO 9952574 A1 describes a biomolecule-repelling coating that was manufactured by immobilizing a terminal, linear, trichlorosilane-modified polyethylene glycol onto glass-like surfaces.

WO 9112886 A1 and WO 9325247 A1 disclose a hydrogel coating that was manufactured from star-shaped polyethylene oxides with the aid of electron irradiation.

EP 335308 A2 describes the use of prepolymers from polyethylene oxide diols and triols, whose terminal OH groups have been reacted with polyisocyanates, for the manufacture of coatings having low nonspecific protein adsorption.

WO 03063926A1 discloses an ultrathin hydrogel coating that was manufactured from star-shaped isocyanate-terminated prepolymers having polyether polymer arms. Hydrogel coatings of this kind effectively suppress nonspecific protein adsorption on surfaces finished therewith.

DE 102004031938 A1 and DE 10332849 A1 furthermore describe the use of such a hydrogel coating in the hygiene and bioanalysis sectors.

Although the hydrogel coatings known from the existing art bring about a decrease to varying degrees in cell and protein adsorption, complex manufacturing methods for these coatings in many cases prevent wide usability.

This includes, for example, the use of coating materials that are reactive, difficult to handle, or complex to synthesize, the use of costly irradiation units, or the need to use adhesion promoters, thereby necessitating laborious coating processes.

Adhesion promoter-free manufacture of hydrophilic hydrogel coatings that are anchored in stably covalent fashion onto substrate surfaces and can be obtained in simple fashion, thereby substantially simplifying the coating process and opening up a broad spectrum of applications, is not known from the existing art.

A need therefore also exists to improve the manufacturing process of such hydrogel coatings, such that, in particular, the use of adhesion promoters can be dispensed with and coatings of long-term stability are nevertheless obtained.

In addition to a decreased tendency for microorganisms to adhere, it is also favorable for reasons of cleaning technology to provide surfaces with hydrophilic properties, since such surfaces can easily be wetted with the usual water-based washing liquids and thus simplify rinsing processes (soil release). These surfaces would, however, at the same time need to be equipped so that water can run off again as completely as possible after wetting, so that a water film does not remain on the surfaces.

The hydrophilic surfaces known from the present existing art are wetted more or less completely with water or with water-based cleaning baths. The water, however, either forms a stable film on the surface or runs off to only a small degree. This has the disadvantage that when the water film dries, residual soiling remains on the surface. What remains, inter alia, are mineral deposits such as, for example, lime deposits, which promote resoiling, including as a result of proteins and microorganisms. For this reason, a need exists for hydrophilic surfaces that facilitate the wetting and release of dirt, but at the same time easily “shed” a water film.

Fabbri et al., J. Sol-Gel Science and Technology 34 (2005) 155-163 disclose a readily water-shedding coating based on perfluoropolyethers and silica (from tetraethoxyorthosilane, TEOS), that nevertheless possesses a large water contact angle, i.e., relative high hydrophobicity. Fabbri et al. also describe fluorine-free and pure TEOS layers (i.e., SiO_{2-x/2}(OH)ₓ) that, with contact angles of approximately 56-58°, possess a hysteresis of 3.6°.

### BRIEF SUMMARY OF THE INVENTION

The present invention pertains to a coating comprising a polymer derived from multi-arm star-shaped prepolymer units and/or star-shaped prepolymer-nanoparticle complexes that are cross-linkable with one another and with the surface of the substrate to be coated wherein the star-shaped prepolymer units are of the formula (II):

(R²—B-A-X)ₙ-Z-(X-A-B—R1)ₘ (II)

wherein Z is a central, multi-arm structural unit; A is a water-soluble, hydrophilic arm; each of B and X is independently a chemical bond or a divalent, low-molecular-weight organic residue having from 1 to 50 carbon atoms; R¹ is a silyl terminal group which is not attached via a polyisocyanates or diisocyanate to the end of the polymer arm; R² is a group which can react with R¹, with the substrate, and/or with itself; and each of m and n is a whole number having a value such that m≧1 and n≧0 and m+n has a value from 3 to 100 with the proviso that when at least one R² residue is an isocyanate residue, m+n has a value from 4 to 100 and is equal to the number of arms of Z, and when the coating is derived from a prepolymer-nanoparticle complex, m≧1 and n≧0 and m+n has a value from 3 to a maximum value of 500,000; wherein the coating has a dynamic contact angle hysteresis in water of less than 15°.

### BRIEF DESCRIPTION OF THE SEVERAL VIEWS OF THE DRAWING(S)

Not Applicable

### DETAILED DESCRIPTION OF THE INVENTION

The disadvantages of the existing art associated with high hydrophobicity values and poor water-shedding properties are overcome in the present invention by making available coatings that possess a dynamic contact angle hysteresis in water, measured by means of a Wilhelmy balance according to DIN EN 14370, of at most 15°, and can be manufactured from star-shaped prepolymers and/or star-shaped prepolymer-nanoparticle complexes that are cross-linkable with one another and with the surface of the substrate to be coated, the star-shaped prepolymers and/or star-shaped prepolymer-nanoparticle complexes possessing, before being cross-linked, at least three hydrophilic polymer arms that, considered of themselves, are soluble in water, and that carry on all or on some of their free ends silyl terminal R¹ groups of the following general formula (I)

R¹ is —CR^{a}₂—Si(OR^{b})ᵣ(R^{c})₃₋ᵣ (I),

where R^{a} denotes hydrogen or a linear or branched alkyl group having 1 to 6 carbon atoms, OR^{b} denotes a hydrolyzable group, R^{c} denotes a linear or branched alkyl group having 1 to 6 carbon atoms, and r denotes a number from 1 to 3, the R¹ silyl terminal groups not being attached via a polyisocyanate—included among, here and hereinafter, are also diisocyanates—to the end of the polymer arm,

and that carry, on the optionally present ends not carrying silyl terminal groups, reactive or functional groups that are reactive with respect to themselves, the substrate to be coated, entities optionally introduced into the coating, and/or with the silyl terminal groups.

Star-shaped prepolymers for purposes of this invention are those that possess polymer arms bound to a central unit, the polymer arms being bound to the central unit in substantially star-shaped or radial fashion, so that one end of the polymer arm is bound to the central unit while the other end is not bound thereto.

Star-shaped prepolymer-nanoparticle complexes for purposes of this invention are those that possess polymer arms bound to a nanoparticle, the polymer arms being bound to the nanoparticles in substantially star-shaped or radial fashion, so that one end of the polymer is bound to the surface of the nanoparticle while another end is not bound to the surface of the nanoparticle.

Preferred embodiments of coatings according to the present invention are described in the claims.

Particularly suitable as star-shaped prepolymers and/or star-shaped prepolymer-nanoparticle complexes preferred for use in the coating are those in which the star-shaped prepolymer and/or the star-shaped prepolymer-nanoparticle complex comprise multiple polymer chains bound to a central unit, and in which, in the case of the star-shaped prepolymer, the central unit by preference is a low-molecular-weight organochemical central unit, and in the case of the star-shaped prepolymer-nanoparticle complex is by preference an inorganic oxide nanoparticle.

Star-shaped prepolymers and/or star-shaped prepolymer-nanoparticle complexes of this kind to be used preferably in the coating according to the present invention possess the following general formula (II):

(R²—B-A-X)ₙ-Z-(X-A-B—R¹)ₘ (II)

in which

Z denotes the central unit, the latter determining, in the case of the star-shaped prepolymers, the number of arms of the multi-arm prepolymers;

A denotes a hydrophilic polymer arm that, considered of itself, is soluble in water;

B and X, mutually independently, denote a chemical bond or a divalent, low-molecular-weight organic residue having by preference 1 to 50 carbon atoms, R¹ the silyl terminal groups not being attached via a polyisocyanate or diisocyanate to the end of the polymer arm;

R² denotes a group cross-linkable with R¹, with the substrate, and/or with itself; and

m and n are each whole numbers, such that in the case of the star-shaped prepolymers, m≧1 and n≧0 and m+n has a value from 3 to 100, and in the case in which at least one R² residue denotes an isocyanate residue has a value from 4 to 100 and corresponds to the number of arms of Z, and the m (X—B—R¹) groups and the n (X—B—R²) groups, mutually independently, can have different meanings; in the case of the prepolymer-nanoparticle complexes, m≧1 and n≧0 and m+n has a value from 3 to a maximum value of 500,000.

In the case of the star-shaped prepolymers, Z preferably denotes a glycerol residue, a polyvalent sugar such as, for example, sorbitol or sucrose. In principle, however, all starter molecules from the literature used for the manufacture of star-shaped prepolymers can be used to constitute the residue Z.

In the case of the star-shaped prepolymer-nanoparticle complexes, Z by preference denotes a silica, zinc oxide, aluminum oxide, zirconium oxide, calcium carbonate, titanium dioxide, carbon, magnesium oxide, or iron oxide nanoparticle. The nanoparticles of group Z either are commercially obtainable or are manufactured in situ or ex situ, preferably by means of sol-gel methods, precipitation from aqueous and nonaqueous solution, gas-phase synthesis (flame pyrolysis, chemical vapor deposition, etc.), mechanical processing (e.g., grinding, ultrasound). Particularly preferably, they have a size from 0.5 to 200 nm, very particularly preferably from 0.5 to 20 nm.

In the case of the star-shaped prepolymer-nanoparticle complexes, the polymer arms A are preferably attached via hydrolyzable silyl terminal groups to the nanoparticle surface of the Z residue. Attachment can, however, also be accomplished via other groups reactive with the surface, such as e.g., carboxyl groups, cationic groups (e.g., trialkylammonium groups), phosphonate groups, etc. Linear polyoxyalkylenediols, both of whose OH groups are reacted with silanes that are reactive with respect to OH groups, for example isocyanate silanes, are particularly suitable for introduction of the polymer arms onto the nanoparticle. Other compounds suitable for introduction of the polymer arms onto the nanoparticle encompass polyether polyol, for example VORANOL®, TERRALOX®, SYNALOX®, and DOWFAX® of Dow Chemical Corporation, SORBETH® of Glyco-Chemicals Inc., GLUCAM® of Amerchol Corp., or Lupranol® and Pluronic® of BASF.

The wettability with water of the coatings according to the present invention is a sensitive indication of their hydrophilic or hydrophobic nature. The contact angle of a water droplet on a planar substrate in air as the surrounding medium results from the surface energies of the coating and of the water, and from the interfacial energy between water and the coating according to the Young equation. In the case of maximum hydrophily, the contact angle approaches 0°. In the maximally hydrophobic case, the contact angle approaches 180°. In practice, the advancing contact angle and retreating contact angle are often measured dynamically using a Wilhelmy balance as defined by DIN EN 14370. Ideally, the difference between the two should be equal to zero. In reality a difference does exist (also called contact angle hysteresis) that is attributed to surface roughness, inhomogeneities, and contaminants. The lower the hysteresis value, the better the coating “sheds” adhering water when a coated substrate is pulled out of the test vessel containing water.

The coatings according to the present invention preferably possess both an advancing and a receding water contact angle of at most 90°, better at most 60°, particularly preferably at most 55°, and very particularly preferably at most 50°. In many cases, however, water contacts angles of 40° and below are also achieved.

Coatings according to the present invention whose dynamic contact angle hysteresis in water, measured according to DIN EN 14370, is at most 15°, particularly preferably at most 10°, and very particularly preferably at most 5°, are preferred. In additionally preferred cases, however, contact angle hystereses of at most 2°, 3°, and 4° and below are also achieved.

In a particular embodiment, the coatings are obtained from star-shaped prepolymers of the general formula (I) or (II), such that the residue OR^{b} is an alkoxy residue, particularly preferably a methoxy or ethoxy residue, and r=1, 2, or 3, particularly preferably 2 or 3. Examples of residues R¹ are dimethylethoxysilyl-CR^{a}₂, dimethylmethoxysilyl-CR^{a}₂, diisopropylethoxysilyl-CR^{a}₂, methyldimethoxysilyl-CR^{a}₂, methyldiethoxysilyl-CR^{a}₂, trimethoxysilyl-CR^{a}₂, triethoxysilyl-CR^{a}₂, or tributoxysilyl-CR^{a}₂ residues.

In the star-shaped prepolymer of the general formula (II), B denotes a chemical bond or a divalent, low-molecular-weight organic residue having by preference 1 to 50, in particular 2 to 20 carbon atoms. Examples of divalent low-molecular-weight organic residues encompass aliphatic, hetereoaliphatic, araliphatic, heteroaraliphatic, cycloaliphatic, cycloheteroaliphatic, and aromatic and heteroaromatic residues. Short-chain aliphatic and heteroaliphatic residues are particularly preferred. Examples of suitable residues encompass aminopropyl, N-(2-aminoethyl)(3-aminopropyl), 3-methacryoxypropyl, methacryloxymethyl, 3-acryloxypropyl, 3-isocyanatopropyl, isocyanatomethyl, butyraldehyde, 3-glycidoxypropyl, propylsuccinic acid anhydride, chloromethyl, 3-chloropropyl, hydroxymethyl.

Those coatings that are obtained from star-shaped prepolymers and/or star-shaped prepolymer-nanoparticle complexes of the general formula (II) in which two adjacent, or all, residues B in the B—R¹ group can construct no more than one, preferably no, hydrogen bridges with one another, are particularly preferred. A coating of this kind having little cross-linking via hydrogen bridges enables greater flexibility in the orientation of the polymer arms A, which in turn results in more uniform distribution of the prepolymers or prepolymer-nanoparticle complexes, and yields a uniform, continuous coating. The presence of a particularly large number of cross-links or particularly strong cross-links by way of hydrogen bridge bonds can additionally cause the materials to become too viscous to be usable in typical application formulations.

Those coatings in which the B residue of the star-shaped prepolymer of the general formula (II) in the B—R¹ group contains at most one urethane, one ester, or one urea group, are therefore particularly preferred.

In a further preferred embodiment, the present invention relates to coatings comprising cross-linked star-shaped prepolymers of the general formula (II) in which the R² residue is preferably selected from the group comprising isocyanate residues, (meth)acrylate residues, oxirane residues, alcoholic OH groups, primary and secondary amino groups, thiol groups, and silane groups. When silane groups are used as R² groups, these can also possess the general formula (I), but they must differ from R¹ in at least one of the R^{a}, R^{b}, and R^{c} groups and/or in the numerical value of r. Suitable as additional R² groups are, for example, oxazoline groups, carboxylic acid groups, carboxylic acid ester, lactone, carboxylic acid anhydride groups, carboxylic acid and sulfonic acid halide groups, active ester groups, residually polymerizable C═C double bonds, e.g., in addition to the aforesaid (meth)acrylic groups also vinyl ether and vinyl ester groups, also activated C═C double bonds, an activated C≡C triple bond, and N═N double bonds that react with allyl groups in the context of an ene reaction or with conjugated diolefin groups in the context of a Diels-Alder reaction. Examples of groups that can react with allyl groups in the context of an ene reaction or with dienes in the context of a Diels-Alder reaction are maleic acid and fumaric acid groups, maleic acid ester and fumaric acid ester groups, cinnamic acid ester groups, propiolic acid (ester) groups, maleic acid amine and fumaric acid amide groups, maleinimide groups, azodicarboxylic acid ester groups, and 1,3,4-triazoline-2,5-dione groups. Particularly preferably, R² in coatings is an isocyanate, oxirane, or OH group.

An advantage of the hydrogel coating according to the present invention as compared with known hydrogel coatings is that its properties can be defined in controlled fashion by appropriate selection of the R¹ and R² residues and their ratio to one another. For example, the wettability, water swellability, and protein and cell repellency can be influenced by controlled adjustment of the R¹:R² ratio.

The coatings according to the present invention contain star-shaped prepolymers whose polymer arms, considered of themselves, are soluble in water. The preferred star-shaped prepolymers of the general formula (II) preferably possess polymer arms A that are selected from the group comprising poly-C₂-C₄ alkylene oxides, polyoxazolidones, polyvinyl alcohols, homo- and copolymers that contain at least 50 wt % polymerized-in N-vinylpyrrolidone, homo- and copolymers that contain at least 30 wt % polymerized-in acrylamide and/or methacrylamide, homo- and copolymers that contain at least 30 wt % polymerized-in acrylic acid and/or methacrylic acid. Particularly preferably, the polymer arms A comprise polyethylene oxide or ethylene oxide/propylene oxide copolymers. If the very particularly preferred ethylene oxide/propylene oxide copolymers are used, a propylene oxide proportion of at most 60 wt %, by preference at most 30 wt %, and particularly preferably at most 20 wt %, is recommended.

The indices m and n of the star-shaped prepolymers and/or star-shaped prepolymer-nanoparticle complexes used in the coatings respectively denote whole numbers, such that m≧1 and n≧0, and m+n preferably has a value from 3 to 100 in the case of the star-shaped prepolymers and preferably a value from 3 to a maximum value of 500,000 in the case of the prepolymer-nanoparticle complexes.

In the case of the star-shaped prepolymers, the indices m and n each denote whole numbers, such that m≧1 and n≧0, and m+n preferably has a value from 3 to 100, or 3 to 50, in particular 4 to 10, and particularly preferably 6 to 10, and corresponds to the number of arms of Z. The central unit therefore generally possesses 3 to 100, preferably 5 to 50, in particular 6 to 10 skeleton atoms that serve as attachment points for the arms.

In the case of the star-shaped prepolymer-nanoparticle complexes, the indices m and n each denote whole numbers, such that m≧1 and n≧0, and m+n preferably possesses a value from 3 to 500,000.

In a particular embodiment, n is equal to 0, the star-shaped prepolymer corresponding to a completely R¹-modified prepolymer that comprises by preference 5 to 50 and in particular 4 to 10, particularly preferably 6 to 10 polymer arms. In the case in which n>0, the ratio n:m varies between 99:1 and 1:99, by preference 49:1 and 1:49, and in particular 9:1 and 1:9.

The star-shaped prepolymer of the coatings according to the present invention preferably has an arithmetically averaged molecular weight in the range from 200 to 50,000, particularly preferably 1,000 to 30,000, and very particularly preferably 5,000 to 20,000 g/mol. The star-shaped prepolymer contains by preference at least 0.05 wt %, particularly preferably at least 0.1 wt %, and very particularly preferably at least 0.15 wt % silicon.

In a particular embodiment, the coating according to the present invention additionally contains foreign materials of organic, inorganic, or natural origin, which hereinafter will be referred to simply as “entities.” An entity is by preference selected from the group comprising biologically active substances, pigments, dyes, fillers, silicic acid units, nanoparticles, organosilanes, biological cells, receptors or receptor-carrying molecules or cells, and is physically incorporated into the coating and/or covalently bonded onto or in it.

Examples of such entities are bioactive materials such as active substances, biocides, oligonucleotides, peptides, proteins, signaling substances, growth factors, cells, carbohydrates and lipids, inorganic components such as apatites and hydroxyapatites, quaternary ammonium salt compounds, compounds of bisguanidines, quaternary pyridinium salt compounds, compounds of phosphonium salts, thiazoylbenzimidazoles, sulfonyl compounds, salicyl compounds, or organometallic and inorganometallic compounds. Antibacterially acting substances such as, for example, peptides, metal colloids, and quaternary ammonium and pyridinium salt compounds are preferred.

A further essential group of entities is represented by organically functionalized silanes (organosilanes) of the type (R′)₁₊ₓSi(OR″)₃₋ₓ (x=0, 1, or 2). What is characteristic here is the simultaneous presence of silicic acid ester groups (OR″) that hydrolyze in aqueous solution to yield condensable silanol groups (Si—OH), and of hydrolysis-stable Si—R′ bonds on the same silicon atom, the latter hydrolysis-stable bond usually comprising a covalent Si—C single bond. The aforesaid functionalized silanes often represent low-molecular-weight compounds, but oligomeric or polymeric compounds are also covered by the term “organically functionalized silanes”; what is essential is that both Si—OR″ groups hydrolyzable to silanol groups, and non-hydrolyzable Si—R′ groups, are present in the same molecule. Because of the (usually organic) R′ groups of the functionalized silanes, it is possible to incorporate the entire spectrum of additional chemical functionalities into the coatings described here. For example, cationic adhesion groups (for example, NR′″₃⁺ groups), anionic adhesion groups (for example —SO₃⁻), redox-active groups (e.g., quinone/hydroquinone residues), dye groups (e.g., azo dye molecules, stilbene-based brighteners), groups having biological or pharmacological activity (including, for example, saccharide or polysaccharide molecule units, peptides or protein units, and other organic structural motifs), groups for covalent attachment to substrates (for example, epichlorohydrin residues, cyanuric chloride, cystine/cysteine units, and the like), groups having bactericidal activity (for example NR′″₃⁺ groups having very long R′″-alkyl residues), catalytically effective groups (for example, transition metal complexes with organic ligands), can be incorporated in this fashion into the layer. Further groups introduced via the R′ residue encompass, for example, epoxy, aldehyde, acrylate, and methacrylate groups, anhydride, carboxylate, or hydroxy groups. The functionalities described here are to be understood as a selection of examples, and in no way as a complete listing. The organosilanes therefore serve not only as a cross-linking aid, but simultaneously as imparters of functionality. A hydrogel coating having desired functionalities is thereby obtained directly.

Likewise included among the entities are nanoparticulate metal or semi-metal oxides. Those of silicon, zinc, titanium, aluminum, zirconium, for example, are suitable. Silicon oxide particles having a diameter from approximately 1 to 500 nm are particularly preferred. SiO₂ particles of this kind, including their surface-modified or surface-functionalized derivatives, can contribute to an improvement in the mechanical properties of the layers.

A further group of entities is represented by inorganic pigments. The coatings according to the present invention having reactive silyl groups attach readily to these via stable covalent bonds. When a hydrogel according to the present invention, i.e., a coating according to the present invention, that is mixed with pigments is applied onto a surface onto which the hydrogel can attach, this then yields bound, pigmented surface coatings. If organic pigments are to be incorporated into the hydrogel, or if adhesion of the hydrogel onto organic surfaces is to be guaranteed, organosilanes having corresponding adhesion groups (e.g., cationic groups as described above) can then be bound into the coating according to the present invention. This makes possible agents and methods with which pigments can be effectively anchored, for example, onto hair. For example, if mica or effect pigments (luster pigments) are attached to hair, particular optical effects (“glitter hair”) are thereby made possible. Particularly intense or stable hair colors are obtained by the use of colored inorganic or organic pigments (for example, lapis lazuli, pyrolopyrrols).

Incorporation of the entities is by preference accomplished by co-adsorption from solutions that contain the star-shaped prepolymer and/or the star-shaped prepolymer-nanoparticle complex and the foreign constituent. The star-shaped prepolymers and/or prepolymer-nanoparticle complexes can furthermore be chemically reacted with the aforesaid bioactive materials, or caused to react, as a mixture with unmodified star-shaped prepolymers and/or prepolymer-nanoparticle complexes, on the surface. It is also possible to apply the foreign substances in controlled fashion, by physisorption or chemisorption, onto the completed hydrogel coating according to the present invention.

The substrates to be coated with the coatings according to the present invention are subject, in principle, to no limitations. The substrates can have regularly or irregularly shaped, smooth, or porous surfaces.

Suitable surface materials are, for example, glass-like surfaces such as glass, quartz, silicon, silicon dioxide, or ceramic, or semiconductor materials, metal oxides, metals, and metal alloys such as aluminum, titanium, zirconium, copper, tin, and steel. Composite materials such as glass-fiber-reinforced (GFR) or carbon-fiber-reinforced (CFR) plastics, polymers such as polyvinyl chloride, polyethylene, polymethylpentene, polypropylene, polyolefins in general, elastomeric plastics such as polydimethylsiloxane, polyesters, fluoropolymers, polyamides, polyurethanes, poly(meth)acrylates, and copolymers, blends, and composites of the aforesaid materials, are suitable as substrates. Cellulose and natural fibers such as cotton fibers, wool, and hair can additionally be used as substrates. Mineral surfaces such as paint coatings or joint material can, however, also serve as substrates. For polymer substrates, it is advisable in some cases to pretreat the surface. Particularly preferred substrate materials are glass-like or, in general, inorganic surfaces, since with these a direct attachment via relatively hydrolysis-stable bonds (e.g., Si—O—Si or Si—O—Al) takes place, and surface pretreatment is therefore unnecessary. If direct formation of (hydrolysis-stable) covalent bonds between the hydrogel and substrate is not achieved as described above, i.e., for example, when organic substrate surfaces are present (Si—O—C bonds are hydrolysis-labile), attachment can be effected advantageously by the addition of organofunctional silanes that possess adhesion groups. Suitable adhesion groups are, for example, cationic trimethylammonium groups or amino groups. Because of the simultaneous presence of reactive siloxyl groups, these functional groups are incorporated into the hydrogel and become essentially an integral, covalently bonded constituent of the coating.

One application that presents itself in the sector of glass, ceramic, plastic, and metal substrates is, for example, the finishing of showers, windows, aquariums, glasses, dishware, sinks, toilets, work surfaces, or kitchen appliances such as, for example refrigerators or stoves, with an easily cleanable temporary or permanent finish that enables water to run off completely, and repels proteins and bacteria.

A further subject of the present invention is a method for producing the coatings according to the present invention on a substrate, such that a solution of a star-shaped prepolymer and/or a star-shaped prepolymer-nanoparticle complex (as defined above) is applied onto the substrate to be coated; and, previously, simultaneously, or subsequently, an at least partial cross-linking reaction of the silyl terminal groups and the optionally present reactive groups of the ends not carrying silyl terminal groups, with one another and/or with the substrate, takes place.

Preferred embodiments of the method according to the present invention are described in the claims.

Preferably, the method is carried out with the star-shaped prepolymers and/or star-shaped prepolymer-nanoparticle complexes of the general formula (II).

In a preferred embodiment of the method according to the present invention, a foreign material, for example an entity selected from the group comprising biologically active substances, pigments, dyes, fillers, silicic acid units, nanoparticles, organosilanes, biological cells, receptors or receptor-carrying molecules or cells, or precursors of the aforesaid entities, are brought into contact with the star-shaped prepolymers before, during, and/or after application of the solution of the star-shaped prepolymer and/or of the star-shaped prepolymer-nanoparticle complex onto the substrate to be coated. The introduced entities can be embedded physically into the network of the cross-linked star-shaped prepolymers and/or star-shaped prepolymer-nanoparticle complexes, or can be bonded ionically to the surface of the coating via van der Waals or hydrogen-bridge bonds, or else can be chemically bound via covalent bonds, preferably via reactive terminal groups of the star-shaped prepolymer.

For example, if silicic acid units are introduced as entities into the coating, this can be accomplished by mixing a solution of the star-shaped prepolymers with a hydrolyzable silicic acid precursor such as, for example, a tetraalkoxysilane (e.g., tetraethoxyorthosilane, TEOS), preferably in the presence of a catalyst such as, for example, an acid or a base. The SiO₂ weight ratio of the introduced silicic acid units, based on the polyethylene:polypropylene oxide proportion in the coating, is by preference 0.01 to 100, particularly preferably 0.5 to 50, and very particularly preferably 1 to 10. Attachment of the silicic acid units to the star-shaped prepolymer can be accomplished via van der Waals bonds, ionically or via hydrogen bridges. Preferably, however, bonding is effected covalently via a —C—Si—O—Si— constellation (Raman or IR detection) to reactive terminal groups of the star-shaped prepolymer and/or star-shaped prepolymer-nanoparticle complex used in the coatings according to the present invention.

The water contact angle (both advancing and receding) of a coating according to the present invention, measured by means of a Wilhelmy balance per DIN EN 14370 on a planar, smooth surface, is by preference 0.0001 to 90°, particularly preferably 0.001 to 60°, and very particularly preferably up to 50° or no more than 40°. The water contact angle hysteresis is by preference no more than 10°, particularly preferably no more than 5°.

Bonding of the silicic acid units to one another can be accomplished in the coating via hydrogen bridges or by ionic interaction. Covalent —Si—O—Si— bridges are, however, preferred (detectable by IR). The effect of TEOS within the layer can be understood as a cross-linking effect, layers without cross-linker (TEOS) usually being more hydrophilic, i.e., being notable for a lower contact angle, for example in the region of 30°. It general, it may be said that the incorporation of additional cross-linkers, for example TEOS or functional alkoxysilanes, represents a further possibility for individually adjusting the properties of the coatings.

Application of the ultrathin hydrogel coatings onto the substrate is accomplished, for example, by depositing the star-shaped prepolymers and/or star-shaped prepolymer-nanoparticle complexes, using methods known per se, onto the surface to be coated from a solution of the prepolymers that can already be partly pre-cross-linked therein, and by simultaneous or subsequent cross-linking of the reactive groups with one another and with the substrate surface.

In general, all known coating methods can be used. Examples thereof are dip coating, spin coating, polishing in, and spray methods. In order to achieve the desired properties of the surface layer, the coating actions are to be selected so that the coating thickness does not exceed by preference a value of 500 μm, particularly preferably 200 μm, and very particularly 100 μm. Depending on the intended applications, a coating must simultaneously meet many different requirements with regard to, for example, mechanical properties, water wetting and water dewetting behavior, protein and bacteria repellency, and the like. For many cases, especially in the household sector, an ultrathin or thin layer having a layer thickness from 0.1 to 100 nm, in particular 1 to 50 nm, is often sufficient to achieve the desired effects, whereas in applications, for example as a result of high mechanical stress on the surfaces, thicker layers having a layer thickness from, for example, 50 to 500 μm, are desired; for some applications, for example those that provide for a presence of nanoparticles in the coating, greater layer thicknesses such as, for example, 1,000 μm may be desirable. In contrast to other hydrophilic hydrogel coatings known from the existing art, with the hydrogel coatings according to the present invention hydrophily remains very large uninfluenced by layer thickness. In other words, the dirt-, protein-, and cell-repelling properties are obtained independently of layer thickness.

A further subject of the present invention is star-shaped prepolymers of the general formula (II), where m and n≧1 mutually independently, and R² does not denote R¹ or OH. Particular embodiments of this subject matter are described in the claims.

All solvents that exhibit little or no reactivity with respect to the reactive terminal groups of the star-shaped prepolymer are generally suitable for manufacture of the solution of the star-shaped prepolymer for the method for manufacturing a coating on a substrate. Examples are water, alcohols, water/alcohol mixtures, aprotic solvents, or mixtures thereof.

Examples of suitable aprotic solvents are, for example, ethers and cyclic ethers such as tetrahydrofuran (THF), dioxane, diethyl ether, tert.-butyl methyl ether, aromatic hydrocarbons such as xylenes and toluene, acetonitrile, propionitrile, and mixtures of said solvents. If star-shaped prepolymers having OH—, SH—, carboxyl, (meth)acrylic, and oxirane groups, or similar groups, as terminal groups are used, protic solvents such as water or alcohols, for example methanol, ethanol, n-propanol, 2-propanol, n-butanol, and tert.-butanol, and mixtures thereof with aprotic solvents, are also suitable. If star-shaped prepolymers having isocyanate groups are used, then in addition to the aforesaid aprotic solvents, water and mixtures of water with aprotic solvents are also suitable. The solvent is by preference water or a mixture of water with aprotic solvents.

Suitable quantities of the star-shaped prepolymers and/or star-shaped prepolymer-nanoparticle complexes in the application mixtures that are used for coating in the method according to the present invention are based on the layer thicknesses best suitable for the particular application. Quantities of, for example, 0.005 to 50 wt %, by preference 0.1 to 10 wt %, are often sufficient. Depending on the affinity of the substrate and the type of application, application mixtures having a higher or even a lower content of star-shaped prepolymers and/or star-shaped prepolymer-nanoparticle complexes can likewise also be used. The application mixtures can, for example, also take the form of pastes or cremes.

Manufacture of the star-shaped prepolymers according to the present invention of the general formula (II) that are used in the coatings according to the present invention and in the method according to the present invention for manufacturing a coating, is accomplished by functionalizing suitable star-shaped prepolymer precursors, by analogy with known functionalization methods of the existing art.

The prepolymer precursors of the prepolymers according to the present invention are also in turn star-shaped prepolymers that already exhibit the above-described star-shaped structure, i.e., have at least three polymer arms that are water-soluble of themselves and that comprise at the end of each polymer arm a suitable R³ functional group that can be converted into the aforesaid B—R¹ or B—R² reactive groups. The prepolymer precursors of the prepolymers according to the present invention can be represented by the general formula (III) as Z-(X-A-R³)ₘ₊ₙ, where Z, X, A, m, and n have the same meaning as the corresponding residues and indices of the star-shaped prepolymers according to the present invention, and R³ represents a functional group that can be converted into the aforesaid B—R¹ or B—R² reactive groups.

Included among the possible R³ functional groups are, for example, thiol groups, primary or secondary amine groups, halogen atoms such as chlorine, bromine, or iodine, and OH groups bound to aliphatic or aromatic hydrocarbon atoms. One particular preferred precursor relates to the primary and secondary OH groups, the star-shaped polyether polyols. These prepolymer precursors are manufactured by polymerization of the suitable monomers utilizing multifunctional small molecules such as, for example, sorbitol as an initiator, and if applicable can be further modified to generate at their ends an —R³ group according to the present invention. Because of the statistical nature of the polymerization reaction, the aforesaid indications regarding the polymer arms of the prepolymers according to the present invention, in particular with respect to arm length and number of arms (m+n), are understood as a statistical mean.

Suitable as starting materials for converting the R³ terminal groups of the star-shaped prepolymer precursor into the B—R¹ groups are, as a rule, all functional silane derivatives that comprise a functional group that is reactive with respect to the terminal groups of the prepolymer precursor. Examples are aminosilanes such as (3-aminopropyl)triethyoxysilane and N-(2-aminoethyl)(3-aminopropyl)trimethoxysilane, (meth)acrylate silanes such as (3-methacryloxypropyl)trimethoxysilane, (methacryloxymethyl)triethoxysilane, (metacryloxymethyl)methyldimethoxysilane, and (3-acryloxypropyl )trimethoxysilane, isocyanatosilanes such as (3-isocyanatopropyl)trimethoxysilane, (3-isocyanatopropyl)triethyoxysilane, (isocyanatomethyl)methyldimethoxysilane, and (isocyanatomethyl)trimethoxysilane, aldehyde silanes such as triethoxysilyl undecanal, and triethoxysilyl butyraldehydes, epoxysilanes such as (3-glycidoxypropyl)trimethoxysilane, anhydride silanes such as 3-(triethoxysilyl)propylsuccinic acid anhydride, halogen silanes such as chloromethyltrimethoxysilane, 3-chloropropylmethyldimethoxysilane, hydroxylsilanes such as hydroxymethyltriethoxysilanes, as well as tetraethyl silicate (TEOS), which are commercially obtainable, for example, from Wacker Chemie GmbH (Burghausen), Gelest, Inc. (Morrisville, USA), or ABCR GmbH & Co. KG (Karlsruhe), or can be manufactured according to known methods. Particularly preferably, isocyanatosilanes or anhydride silanes having hydroxy-terminated (R³═OH) star-shaped polymers of the general formula (III) are reacted. A complete reaction of all hydroxy termini with isocyanatosilanes yields star-shaped prepolymers according to the present invention that carry exclusively R¹ residues. In such a case, the B group contains a urethane group as well as the atomic group that is located, in the original isocyanatosilane, between the isocyanato group and the silyl group. A complete reaction of all the hydroxy termini with anhydride silanes, for example 3-(triethoxysilyl)propylsuccinic acid anhydride, yields star-shaped prepolymers according to the present invention that carry exclusively R¹ residues. In such a case, the B group contains an ester group as well as the atomic group located, in the original anhydride silane, between the anhydride group and the silyl group.

All diisocyanates, both aromatic and aliphatic, are suitable as a rule as starting materials for converting the R³ terminal groups of the star-shaped prepolymer precursors into the B—R² groups, by preference an isocyanate group. Diisocyanates whose isocyanate groups differ in terms of their reactivity are preferred; aliphatic and cycloaliphatic diisocyanates such as isophorone diisocyanate (IPDI) are particularly preferred. When hydroxy-terminated star-shaped prepolymers react with diisocyanates, urethane groups are also formed in the B residue. The “B” residue can, however, have a different meaning in each of the m+n polymer arms within the star-shaped prepolymers according to the present invention.

When star-shaped prepolymers according to the present invention of the general formula (II) that carry both B—R¹ and B—R² groups are manufactured, the procedure is preferably such that, as described above, firstly B—R¹ groups are introduced, but not all R³ groups in the star-shaped prepolymer of the general formula (III) are reacted. This immediately yields star-shaped prepolymers that carry both —R¹ and —R² groups, this being the particular case in which —R² is identical to —R³. A partial reaction of all hydroxy termini with isocyanatosilanes, for example, yields star-shaped prepolymers according to the present invention that carry both R¹ residues (i.e., silyl groups) and OH groups (R²═R³). In a further step, the remaining, or a portion of the remaining, R³ groups can be modified, as described, to yield R² or B—R² residues. If —R² represents a (meth)acrylate group, an example is the esterification of the remaining OH groups with (meth)acrylic acid anhydride. In most cases this is also successful in a reversed reaction sequence, i.e., the —R³ group of the star-shaped prepolymers can first be converted into —R², and then reacted with a functional alkoxysilane in order to introduce the —R¹ group.

A further subject of the present invention is derivatives of the prepolymers according to the present invention that are obtained by reaction of the R¹ and/or R² groups with the aforesaid entities, and are claimed.

In addition to the star-shaped prepolymers according to the present invention, other star-shaped prepolymers can also be used to form the coatings according to the present invention, provided they meet the conditions according to the present invention as defined in Claim 1.

In the simplest embodiments only the minimum requirements regarding the coatings according to the present invention are met. For example, star-shaped prepolymers in which the molecules carrying silyl groups are linked via diisocyanates are more poorly suited for forming uniformly sealed coatings than are star-shaped prepolymers of the general formula (II) in which B contains at maximum one urethane or urea bond. It is especially with particularly well-sealed layers that substrates can be protected from a much broader spectrum of stains.

Star-shaped prepolymers known from the literature can be used only under the preconditions recited above in the coatings according to the present invention and in the coating method according to the present invention.

EP 0931800 A1 relates to a silylated polyurethane that was manufactured by first reacting a polyol with a stoichiometric deficiency of diisocyanate and then reacting the resulting isocyanate hydroxypolol with isocyanatosilanes.

US 2003 0153712 A1 describes a polyurethane prepolymer having terminal alkoxysilane and hydroxy groups. For manufacture, firstly a polyether diol was reacted with a stoichiometric deficiency of diisocyanate, and the resulting isocyanate-hydroxy compound was then further reacted with an aminosilane for introduction of the silyl groups.

EP 0935627 A1 discloses a star-shaped prepolymer based on polyether, which prepolymer carries at its free ends two differently reactive R¹ and R²functional groups. Here R¹ denotes an isocyanate group, while R² represents a group that is non-reactive with R¹ under normal conditions. For the manufacture of such prepolymers, all the OH groups of the polyether polyols were firstly reacted with a stoichiometric excess of diisocyanates, and the NCO prepolymers thus obtained were further treated with a stoichiometric deficiency of a bifunctional compound that carries an isocyanate-reactive terminal group and a different non-isocyanate-reactive terminal group. Such prepolymers can be used, for example, to coat surfaces.

US 2002 0042471 A1 and US 2003 0027921 A1 disclose prepolymers having 2 to 6 isocyanate groups that are further modified with a stoichiometrically deficient quantity of aminosilane. The prepolymers obtained have both NCO and silane groups, and are used together with a polyol as a coating material.

U.S. Pat. No. 6,423,661 B1 and WO 9955765 A1 describe a silyl-terminated prepolymer based on polyether. For manufacture, all the OH groups of a polyether polyol were reacted with a stoichiometric excess of isocyanatosilane. Such prepolymers are used as adhesives.

A similar compound, a six-armed silyl-terminated polyethylene glycol, has been described in US 2004 0096507 A1.

The hydrogel coatings according to the present invention manufactured using star-shaped prepolymers and/or star-shaped prepolymer-nanoparticle complexes effectively prevent the adsorption of proteins and cells and can be used for many applications, for example in the hygiene and bioanalysis sectors. Such a use is therefore also, among others, a subject of the present invention.

A further subject of the present invention is the use of the star-shaped prepolymers according to the present invention, derivatives thereof, and/or the star-shaped prepolymers and/or star-shaped prepolymer-nanoparticle complexes used in the coating agents according to the present invention, in anti-soiling agents for temporary or permanent finishing of surfaces. An essential prerequisite for this is the hydrophilic surface behavior simultaneously with low contact angle hysteresis. The hydrophily of the surface on the one hand interferes with the adsorption and adhesion of protein- and grease-containing stains, and on the other hand permits efficient wetting with cleaning agents, with the result that contaminants can be separated from the substrate more easily than with hydrophobic surfaces. The dewetting, or complete runoff of the cleaning solution, characterized by the lower contact angle hysteresis furthermore effectively prevents redeposition of dirt onto the freshly cleaned surfaces.

A further use according to the present invention of the star-shaped prepolymers according to the present invention, derivatives thereof, and/or the star-shaped prepolymers and/or star-shaped prepolymer-nanoparticle complexes used in the coating agents according to the present invention, consists in the use thereof as additives in cleaning agents and washing agents for hard and soft surfaces, such as those used, for example, in the sanitary or kitchen sector, in order to prevent or reduce staining or re-staining, in hair-care agents, textile treatment agents, wall, siding, and joint treatment agents, in agents for treating vehicles, such as automobiles, aircraft, ships, or boats (anti-fouling), and in agents for internal and external coating of containers in order to enable, for example, loss-free emptying of the containers, or in agents for coating bioreactors and heat exchangers, for example in order to prevent the adhesion of microorganisms.

A further use according to the present invention of the star-shaped prepolymers according to the present invention, derivatives thereof, and/or the star-shaped prepolymers and/or star-shaped prepolymer-nanoparticle complexes used in the coating agents according to the present invention, is represented by use in coatings to influence the growth or crystallization of solids onto the surface. Because of their sealed structure, their hydrophily, and the ease with which they can be chemically functionalized (for example with entities), it is possible with the hydrogel layers according to the present invention, in principle, to adjust the biological situation in the context of biomineralization procedures. One example of a typical biomineralization procedure that may be named is the formation of mussel shells from calcium carbonate, which formation is controlled by specifically structured and functionalized hydrophilic polymer layers. Nature teaches here that by way of the details of the chemical structure of such hydrophilic polymers, the growth of solids out of solution can be promoted and/or controlled, or else prevented. Lime crystallization onto surfaces may be named here as a technically and economically relevant growth process. The growth of lime can be prevented by way of the hydrogel layers according to the present invention, optionally by adding suitable entities. Lime deposition is also prevented, beyond the substrate action discussed here, by the fact that as mentioned, water is shed from the coated surfaces and crystallization is thus prevented because of this simple physical effect. The hydrogel-based anti-lime coating can be of a permanent or else a temporary nature.

By incorporating suitable entities it is, however, possible not only to prevent the growth of solids but also, conversely, to induce in controlled fashion the growth (if applicable, in crystallographically oriented fashion) of solids onto substrates, preferably that of such solids having technically useful functionalities. The exact details of the chemical composition of the coating, in particular the entities, thus make possible general control of the growth of solids.

A further use according to the present invention of the star-shaped prepolymers according to the present invention, derivatives thereof, and/or the star-shaped prepolymers and/or star-shaped prepolymer-nanoparticle complexes used in the coating agents according to the present invention, is in the manufacture of microarrays or sensors for bioanalytical purposes or for coating microfluidic components or for coating microcannulae and capillary systems, for example for the introduction of genetic material into cells. Here the hydrogel coating on the one hand permits the selective coupling of biomolecules to the coating if the latter has, for example, receptors bound to it as an entity, and on the other hand it is notable for a particularly low affinity for unspecific binding of biomolecules. The hydrogel coatings are thus particularly suitable as a coating primer of substrates for bioanalysis systems.

The subjects of the present invention are therefore also anti-soiling agents, cleaning agents and washing agents for hard and soft surfaces, hair-care agents, textile treatment agents, wall, siding, and joint treatment agents, agents for treating vehicles, agents for internal and external coating of containers, bioreactors, and heat exchangers, containing the star-shaped prepolymers according to the present invention.

A further use according to the present invention of the star-shaped prepolymers according to the present invention, derivatives thereof, and/or the star-shaped prepolymers and/or star-shaped prepolymer-nanoparticle complexes used in the coating agents according to the present invention, is the provision of surfaces with modified, in particular reduced, friction properties. If the coatings are, for example, applied onto textiles, a more pleasant “hand” is produced; when applied to hair, for example, combability is improved.

The use of these compounds or complexes to decrease static electric charges is also a subject of this invention. Stable hydrophilic coatings on, for example, hair prevent negative electrostatic effects over long periods. The same also applies to textiles.

A further use according to the present invention of the star-shaped prepolymers according to the present invention, derivatives thereof, and/or the star-shaped prepolymers and/or star-shaped prepolymer-nanoparticle complexes used in the coating agents according to the present invention, consists in fixing or retaining dyes on fibers by way of the hydrogel coating on textiles, either because of the hydrogel structure itself or because of additional functionalities that are introduced preferably by way of the aforementioned entities. A color protection effect is thereby achieved that can be utilized, for example, in a no-sort laundry detergent, i.e. a laundry detergent with which colored and white laundry can be washed.

### EXAMPLES

### Manufacturing the Prepolymers.

### Example 1

Six-armed triethyoxysilyl-terminated polyether (PP1). The polyether polyol used is a 6-armed statistical poly(ethylene oxide co-propylene oxide) having an EO:PO ratio of 80:20 and a molecular weight of 12,000 g/mol, that was manufactured by anionic ring-opening polymerization of ethylene oxide and propylene oxide using sorbitol as an initiator. Prior to reaction, the polyol was heated under vacuum with agitation for 1 hour at 80° C.

A solution of polyether polyol (3 g, 0.25 mmol), triethylenediamine (9 mg, 0.081 mmol) and dibutyl tin dilaurate (9 mg, 0.014 mmol) in 25 ml anhydrous toluene was prepared, and a solution of (3-isocyanatopropyl)triethoxysilane (0.6 ml, 2.30 mmol) in 10 ml anhydrous toluene was added to it dropwise. Stirring of the solution continued overnight at 50° C. After removal of the toluene under vacuum, the raw product was rinsed repeatedly with anhydrous ether. After vacuum drying, the product was obtained as a colorless viscous liquid; it has a triethyoxylsilyl group at each of the free ends of the polymer arms of the star-shaped prepolymer. IR (film, cm⁻¹): 3349 (m, —CO—NH—), 2868 (s, —CH₂—, —CH₃), 1719 (s, —C═O), 1456 (m, —CH₂, —CH₃), 1107 (s, —C—O—C—), 954 (m, —Si—O—). ¹H-NMR (benzene-d₆, ppm): 1.13 (d, —CH₃ of polymer arms), 1.21 (t, —CH₃ of silane terminal groups), 3.47 (s, —CH₂ of polymer arms), 3.74 (q, —CH₂ of silane terminal groups).

### Example 2

Six-armed triethoxysilyl/hydroxy-terminated polyether (PP2). Analogously with Example 1, a solution of polyether polyol (10 g, 0.83 mmol), triethylenediamine (30 mg, 0.27 mmol) and dibutyl tin dilaurate (30 mg, 0.048 mmol) in 50 ml anhydrous toluene was prepared, and a solution of (3-isocyanatopropyl)triethoxysilane (0.65 ml, 2.49 mmol) in 15 ml anhydrous toluene was added to it dropwise. Stirring of the solution continued overnight at 50° C. After removal of the toluene under vacuum, the raw product was analyzed by IR. The results showed that the typical vibrations of the NCO group at approx. 2270 cm⁻¹ had completely disappeared and, associated therewith, decreased OH vibrations at approx. 3351 cm⁻¹ were visible; this indicates that the isocyanatosilane molecules were successfully attached to the ends of the polyol via a urethane bond. The raw product was then rinsed repeatedly with anhydrous ether. After vacuum drying, the product was obtained as a colorless viscous liquid; it has triethyoxylsilyl and hydroxy groups, at a statistical ratio of 3:3, at the free ends of the polymer arms of the star-shaped prepolymer. IR (film, cm⁻¹): 3511, (m, —OH), 3351 (m, —CO—NH—), 2868 (s, —CH₂—, —CH₃), 1720 (s, —C═O), 1456 (m, —CH₂, —CH₃), 1112 (s, —C—O—C—), 953 (m, —Si—O—). ¹H-NMR (benzene-d₆, ppm): 1.08-1.17 (m, —CH₃ of polymer arms and —CH₃ of silane terminal groups), 3.47 (s, —CH₂ of polymer arms), 3.74 (q, —CH₂ of silane terminal groups).

### Example 3

Six-armed triethoxysilyl/hydroxy-terminated polyether (PP3). Analogously with Example 1, a solution of polyether polyol (10 g, 0.83 mmol), triethylenediamine (30 mg, 0.27 mmol) and dibutyl tin dilaurate (30 mg, 0.048 mmol) in 50 ml anhydrous toluene was prepared. A solution of (3-isocyanatopropyl)triethoxysilane (0.22 ml, 0.84 mmol) in 15 ml anhydrous toluene was added to it dropwise. Stirring of the solution continued overnight at 50° C. After removal of the toluene under vacuum, the raw product was rinsed repeatedly with anhydrous ether. After vacuum drying, the product was obtained as a colorless viscous liquid; it has triethyoxylsilyl and hydroxy groups, at a statistical ratio of 1:5, at the free ends of the polymer arms of the star-shaped prepolymer. IR (film, cm⁻¹): 3494, (m, —OH), 3346 (w, —CO—NH—), 2868 (s, —CH₂—, —CH₃), 1722 (m, —C═O), 1456 (m, —CH₂, —CH₃), 1112 (s, —C—O—C—), 952 (m, —Si—O—). ¹H-NMR (benzene-d₆, ppm): 1.08-1.18 (m, —CH₃ of polymer arms and —CH₃ of silane terminal groups), 3.49 (s, —CH₂ of polymer arms), 3.75 (q, —CH₂ of silane terminal groups).

Further triethyoxysilyl/hydroxy-terminated polyethers were manufactured analogously with Examples 2 and 3.

### Example 4

Triethoxysilyl and hydroxy groups (triethyoxysilyl:OH ratio=2:4; PP4): Colorless viscous liquid. IR (film, cm⁻¹): 3496, (m, —OH), 3351 (w, —CO—NH—), 2869 (s, —CH₂—, —CH₃), 1721 (m, —C═O), 1459 (m, —CH₂, —CH₃), 1107 (s, —C—O—C—), 953 (m, —Si—O—). ¹H-NMR (benzene-d₆, ppm): 1.05-1.16 (m, —CH₃ of polymer arms and —CH₃ of silane terminal groups), 3.47 (s, —CH₂ of polymer arms), 3.74 (q, —CH₂ of silane terminal groups).

### Example 5

Triethoxysilyl and hydroxy groups (triethyoxysilyl:OH ratio=5:1; PP5): Colorless viscous liquid. IR (film, cm⁻¹): 3512, (m, —OH), 3351 (w, —CO—NH—), 2867 (s, —CH₂—, —CH₃), 1715 (m, —C═O), 1457 (m, —CH₂, —CH₃), 1116 (s, —C—O—C—), 952 (m, —Si—O—). ¹H-NMR (benzene-d₆, ppm): 1.08-1.17 (m, —CH₃ of polymer arms and —CH₃ of silane terminal groups), 3.47 (s, —CH₂ of polymer arms), 3.74 (q, —CH₂ of silane terminal groups).

### Example 6

Triethoxysilyl and hydroxy groups (triethyoxysilyl:OH ratio=4:2; PP6): Colorless viscous liquid. IR (film, cm⁻¹): 3513, (m, —OH), 3351 (w, —CO—NH—), 2867 (s, —CH₂—, —CH₃), 1721 (m, —C═O), 1455 (m, —CH₂, —CH₃), 1106 (s, —C—O—C—), 954 (m, —Si—O—). ¹H-NMR (benzene-d₆, ppm): 1.05-1.16 (m, —CH₃ of polymer arms and —CH₃ of silane terminal groups), 3.46 (s, —CH₂ of polymer arms), 3.73 (q, —CH₂ of silane terminal groups).

### Example 7

Six-armed triethoxysilyl/isocyanate-terminated polyether (PP7). A mixture of the product of Example 2 (4 g, 0.32 mmol), isophorone diisocyanate (IPDI, 3.2 ml, 15.1 mmol), and 7 ml anhydrous toluene was stirred for 48 hours at 50° C. After removal of the toluene under vacuum, the raw product was rinsed repeatedly with anhydrous ether. After vacuum drying, the product was obtained as a colorless viscous liquid; it has triethyoxylsilyl and isocyanate groups, at a statistical ratio of 3:3, at the free ends of the polymer arms of the star-shaped prepolymers. IR (film, cm⁻¹): 3335 (w, —CO—NH—), 2869 (s, —CH₂—, —CH₃), 2266 (s, —NCO), 1717 (s, —C═O), 1458 (m, —CH₂, —CH₃), 1111 (s, —C—O—C—), 953 (m, —Si—O—). ¹H-NMR (benzene-d₆, ppm): 1.11-1.18 (m, —CH₃ of polymer arms and —CH₃ of silane terminal groups), 3.49 (s, —CH₂ of polymer arms), 3.75 (q, —CH₂ of silane terminal groups).

### Example 8

Six-armed triethoxysilyl/isocyanate-terminated polyether (PP8). A mixture of the product of Example 3 (4.7 g, 0.38 mmol), isophorone diisocyanate (IPDI, 5.65 ml, 26.7 mmol), and 5 ml anhydrous toluene was stirred for 48 hours at 50° C. After removal of the toluene under vacuum, the raw product was rinsed repeatedly with anhydrous ether. After vacuum drying, the product was obtained as a colorless viscous liquid; it has triethyoxylsilyl and isocyanate groups, at a statistical ratio of 1:5, at the free ends of the polymer arms of the star-shaped prepolymers. IR (film, cm⁻¹): 3335 (w, —CO—NH—), 2869 (s, —CH₂—, —CH₃), 2266 (s, —NCO), 1717 (s, —C═O), 1458 (m, —CH₂, —CH₃), 1112 (s, —C—O—C—), 952 (m, —Si—O—). ¹H-NMR (benzene-d₆, ppm): 1.11-1.18 (m, —CH₃ of polymer arms and —CH₃ of silane terminal groups), 3.48 (s, —CH₂ of polymer arms), 3.75 (q, —CH₂ of silane terminal groups).

Further triethyoxysilyl/isocyanate-terminated polyethers were manufactured analogously with Examples 7 and 8.

### Example 9

Triethoxysilyl and isocyanate groups (triethyoxysilyl:NCO ratio=2:4; PP9): Colorless viscous liquid. IR (film, cm⁻¹): 3335 (w, —CO—NH—), 2869 (s, —CH₂—, —CH₃), 2265 (s, —NCO), 1718 (s, —C═O), 1460 (m, —CH₂, —CH₃), 1112 (s, —C—O—C—), 952 (m, —Si—O—). ¹H-NMR (benzene-d₆, ppm): 1.11-1.17 (m, —CH₃ of polymer arms and —CH₃ of silane terminal groups), 3.48 (s, —CH₂ of polymer arms), 3.75 (q, —CH₂ of silane terminal groups).

### Example 10

Triethoxysilyl and isocyanate groups (triethyoxysilyl:NCO ratio=5:1; PP10): Colorless viscous liquid. IR (film, cm⁻¹): 3342 (w, —CO—NH—), 2869 (s, —CH₂—, —CH₃), 2265 (s, —NCO), 1719 (s, —C═O), 1460 (m, —CH₂, —CH₃), 1114 (s, —C—O—C—), 954 (m, —Si—O—). ¹H-NMR (benzene-d₆, ppm): 1.09-1.17 (m, —CH₃ of polymer arms and —CH₃ of silane terminal groups), 3.48 (s, —CH₂ of polymer arms), 3.75 (q, —CH₂ of silane terminal groups).

### Example 11

Triethoxysilyl and isocyanate groups (triethyoxysilyl:NCO ratio=4:2; PP11): Colorless viscous liquid. IR (film, cm⁻¹): 3340 (w, —CO—NH—), 2869 (s, —CH₂—, —CH₃), 2265 (s, —NCO), 1719 (s, —C═O), 1459 (m, —CH₂, —CH₃), 1109 (s, —C—O—C—), 953 (m, —Si—O—). ¹H-NMR (benzene-d₆, ppm): 1.12-1.17 (m, —CH₃ of polymer arms and —CH₃ of silane terminal groups), 3.49 (s, —CH₂ of polymer arms), 3.75 (q, —CH₂ of silane terminal groups).

### Manufacturing the Hydrogel Coatings.

### Example 12

Small glass plates and silicon wafers (Si [100]) were used as substrates. Prior to coating, the substrates were stored for 1 hour at 60° C. in a mixture of concentrated aqueous ammonia, hydrogen peroxide (25-wt %) and water at a volume ratio of 1:1:5, and then rinsed several times with water. After drying, they were used for coating.

For coating, the prepolymer (PP7 and PP8) was dissolved in water (pH=2.5, adjusted with hydrochloric acid). After 5 minutes the prepolymer was applied onto the cleaned substrate using a spin coater (4,000 rpm for 40 seconds). The coated substrates were stored at room temperature for 24 hours in an atmosphere at approximately 50% relative humidity, and then used for the further investigations.

### Example 13

A hydrogel coating comprising a six-armed isocyanate-terminated polyether prepolymer (PP12, comparison prepolymer) was produced, analogously with the literature (J. Groll et al., Biomacromolecules 2005, 6, 956-962), directly on the substrate cleaned as in Example 12. For coating, the prepolymer (PP2 and PP7) was dissolved in water (pH=1.0, adjusted with hydrochloric acid). After 5 minutes the prepolymer was applied onto the cleaned substrate using a spin coater (2500 rpm for 40 seconds). The coated substrates were stored at room temperature (RT) in an atmosphere at approximately 50% relative humidity for 24 hours, and then used for the further investigations.

### Investigations on Hydrogel Coatings.

### Example 14

Stability investigation of hydrogel coatings. The hydrogel coatings PP12 (comparison prepolymer), PP2, and PP7 manufactured in Example 13 were stored in water and removed after a specific time span in order to assess the coatings in terms of their detachment characteristics. After approximately 2 days, it was found that coating PP12 had completely detached from the surface, while coatings PP2 and PP7 remained unchanged. This result was also confirmed by ellipsometric layer thickness measurements.

### Example 15

Fluorescence-microscopy investigation of protein adsorption onto hydrogel surfaces. The hydrogel coating was produced, as described in Example 12, on a silicon wafer using prepolymer PP7. Protein adsorption experiments were performed analogously with the literature (J. Groll et al., Biomacromolecules 2005, 6, 956-962). One-half of the substrates coated with hydrogel was coated by dip-coating with polystyrene (from a 2-percent solution of polystyrene in toluene and at a rate of 10 mm/min). The specimen was then incubated in a solution of streptavidin/Rhodamine Red conjugate (5 μg/ml) in PBS buffer (pH 7.4) for 20 minutes. After thorough rinsing with PBS buffer and demineralized water, the specimen was investigated using fluorescence microscopy. The result showed that the hydrogel coating is protein-repelling, since the fluorescence-labeled proteins were adsorbed only onto the surface treated with polystyrene, but not onto the hydrogel-coated side of the substrate.

### Example 16

Mass spectrometric investigation of protein adsorption onto hydrogel surfaces. The hydrogel coatings were produced, as described in Example 12, on a silicon wafer using prepolymers PP7 and PP8, and protein adsorption experiments were performed analogously with the literature (J. Groll et al., Biomacromolecules 2005, 6, 956-962). The specimens were incubated in a solution of lysozyme or insulin (1 mg/ml) in 0.1 M carbonate buffer (pH 8.3) at 37° C. for 1 hour. After thorough rinsing with buffer and demineralized water, the specimens were investigated with a surface-sensitive MALDI-ToF mass spectrometer set up for this purpose. The characteristic peaks for lysozyme or insulin were easily identifiable in the reference spectra measured on the cleaned silicon wafers. The results showed that no adsorption of lysozyme or insulation was detectable on the hydrogel surfaces according to the present invention.

### Example 17

Array with strip-shaped regions of a biotin-streptavidin system. The hydrogel coating was produced, as described in Example 12, on a silicon wafer using prepolymer PP7. A rectangular polydimethyidisiloxane die, produced and activated according to Groll et al., Langmuir 2005, 21, 3076, having an area of approx. 15×15 mm and a regular arrangement of strip-shaped elevations (5 μm wide, 2 μm high, average spacing 10 μm) was wetted with a solution of biotinamidohexanoic acid N-hydroxysuccinimide ester (Molecular Probes) in absolute dimethylformamide (1 mg/ml) and then dried. The die thus obtained was brought into contact with the aforesaid hydrogel coating for 5 minutes. After removal of the die, the surface thus obtained was thoroughly washed with water to remove non-bound ester, and dried in a filtered stream of argon. A surface having strip-shaped regions of immobilized biotin was thereby obtained. The biotin surface manufactured in this fashion was incubated for 20 minutes with a solution of fluorescence-labeled streptavidin (streptavidin/Rhodamine Red conjugate, Molecular Probes, 5 μg/ml in PBS buffer (pH=7.4)). This was followed by rewashing with PBS buffer and water, drying in a stream of argon, and investigation by fluorescence microscopy. The result showed a red-emitting strip with a dark background. This shows that the biotin-streptavidin complexes form selectively on the surface, and confirms on the one hand the successful spatially resolved immobilization of biotin on hydrogel surfaces, and on the hand the protein-repelling property of the non-functionalized hydrogel surfaces, since fluorescence-labeled streptavidin was not observed on the biotin-free strips.

### Example 18

Stability in water of a coating produced by a spray method. A mixture of the prepolymer according to the present invention (PP1, 3.1 wt %), water (1.6 wt %), and acetic acid (1.6 wt %) in ethanol was stirred at room temperature for 2 days. This mixture was then diluted tenfold with water and sprayed onto cleaned tile surfaces. After drying (approx. 10 mins.) a coating was obtained that is hydrophilic (water contact angle 40°) and at the same time water-repellent (at a tilt angle of approx. 10°, water droplets rapidly run off). The coated tile was then immersed in water and assessed for changes over time. After one week no change was observed in terms of water runoff characteristics from the surface, which suggests that the coating is stable under the conditions indicated.

### Example 19

Water contact angle and hysteresis of a coating produced using a spray method. A mixture of the prepolymer according to the present invention (PP1, 3.0 wt %), TEOS (6.0 wt %), water (1.5 wt %), and acetic acid (1.5 wt %) in ethanol was stirred at room temperature for 2 days. It was then diluted twofold with water and sprayed onto a cleaned glass surface. After rinsing with water, a coating was obtained whose water contact angle was determined using a Wilhelmy balance, and found to be 39° (advancing) and 34° (receding). The water contact angle hysteresis was therefore 5°.

### Example 20

Incorporation into cleaning agents as an additive. A mixture of the prepolymer according to the present invention (PP1, 3.1 wt %), water (1.6 wt %), and acetic acid (1.6 wt %) in ethanol was stirred at room temperature for 2 days. It was then diluted tenfold with a commercially available liquid bath cleaner, and sprayed onto tile and glass surfaces. After wiping with a soft cloth, the surface was rinsed with water. A coating was thereby obtained that behaves exactly like the coating in Example 18.

A coating having the same properties and effects can likewise be produced directly from the prepolymer according to the present invention, for example as described below. A solution of the prepolymer according to the present invention (PP1, 0.3 wt %) is a commercially available liquid bath cleaner was stirred at room temperature for two days. It was then sprayed onto tile and glass surfaces. After being wiped off with a soft cloth, the surface was rinsed with water. A coating was thereby obtained that behaves like the one described above.

### Example 21

Producing a coating on glass. A mixture of prepolymer (PP1 and PP2, each 1.0 wt %), TEOS (2 wt %), water (0.5 wt %) and acetic acid (0.5 wt %) in ethanol was stirred at room temperature for 2 days. It was then applied, either directly or after the addition of dimethyl benzylamine (DMBA, 0.1 wt % in terms of the aforesaid mixture), onto cleaned glass surfaces (dip coating at a rate of 10 mm/min). The water contact angles, and their hysteresis values, on the coatings thus obtained were determined by means of a Wilhelmy balance per DIN EN 14370. The results are shown in the table below:

| Coatings | θ_{advancing} (degrees) | θ_{receding} (degrees) | Hysteresis |
|---|---|---|---|
| PP2 | 40.1 | 38.7 | 1.4 |
| PP2 with DMBA | 42.0 | 39.2 | 2.8 |
| PP1 | 44.7 | 41.1 | 3.6 |
| PP1 with DMBA | 46.6 | 41.8 | 4.8 |

Dynamic contact angles were determined, as indicated above, using a Wilhelmy balance (computer-controlled contact angle instrument of Lemke & Partner, Kaarst, with “Contact Angle” evaluation software, version 3.60). The actual surface tension of the double-distilled water used for this was determined prior to the measurements using a platinum standard (Krüss). The coated substrate was then measured (20 mm wide, 1 mm thick), and was slowly immersed 0.5 cm into, and pulled back out of, this water over a period of 90 minutes at a constant rate. The forces resulting in this context, in combination with the geometry of the substrate, the surface tension of the water, and the withdrawal rate, yield values for the advancing and retreating contact angle.

### Example 22

Producing a coating on tiles. A mixture of prepolymer (PP1, 1.0 wt %), TEOS (2.0 wt %), water (0.5 wt %) and acetic acid (0.5 wt %) in ethanol was stirred at room temperature for 2 days. It was then diluted tenfold with water and sprayed onto cleaned tile surfaces. After drying (approx. 10 minutes), a coating was obtained that is hydrophilic (water contact angle 40°) and at the same time water-shedding (low hysteresis). Because of these unique properties, this coating exhibits an easy-cleaning effect that was proven using the standard IKW ballast soiling test (literature: SÖFW-Journal, 1998, 124, 1029). Because water droplets quickly run off from this surface, lime deposition thereon can be effectively prevented; this in turn was confirmed experimentally under conditions similar to the real world.

A coating having similar properties and effects, but without the addition of TEOS, can also be produced from the aforesaid mixture. For this, for example, a mixture of prepolymer (PP1, 1.0 wt %), water (0.5 wt %) and acetic acid (0.5 wt %) in ethanol was stirred at room temperature for 2 days. It was then diluted tenfold with water and sprayed onto cleaned tile surfaces. After drying (approx. 10 minutes), a coating was obtained that behaves like the coating described previously.

### Example 23

Easy-to-clean effect on glass. A PP1 coating produced according to Example 22 on a glass surface was coated with IKW ballast soil, produced according to SÖFW-Journal 1998, 124, 1029, and dried overnight at room temperature; an untreated glass surface served as reference. After drying, the surfaces were washed off with running water. Under identical washing conditions, it was apparent that the IKW ballast soiling on a PP1 coating is completely removed, whereas a white greasy layer remains behind on uncoated glass surfaces. The easier cleaning effect on the coating is further confirmed by an Edding® test: an Edding® waterproof marker was used to write on the aforesaid coating and on the reference. After drying, the surfaces were washed off under running water. After only a short time (less than 1 min.), the Edding® marks on the PP1 coating were completely removed, whereas on uncoated glass surfaces they remained unchanged even after a longer period (more than 10 min.).

### Example 24

Easy-to-clean effect on tiles. A coating produced according to Example 23 on a tile surface was coated with IKW ballast soil, produced according to SÖFW-Journal 1998, 124, 1029, and dried overnight at room temperature; an untreated tile surface served as reference. After drying, the surfaces were washed off with running water. Under identical washing conditions, it was apparent that the IKW ballast soiling on the coating is completely removed, whereas a white greasy layer remains behind on uncoated tile surfaces.

### Example 25

Anti-lime effect. A coating produced according to Example 23 on a tile surface was set up on a slightly tilted (approx. 30°) test apparatus. Tap water was applied continuously and dropwise onto the tile surface; an untreated tile surface served as reference. Because of the low contact angle hysteresis, the water droplets quickly ran off from the coating with almost no change in shape, whereas on the untreated tile surfaces they left behind a long water trail. After one week, it is unequivocally apparent that lime becomes deposited onto the untreated surfaces but not onto the treated surfaces.

1. A coating comprising a polymer derived from multi-arm star-shaped prepolymer units and/or star-shaped prepolymer-nanoparticle complexes that are cross-linkable with one another and with the surface of the substrate to be coated wherein the star-shaped prepolymer units are of the formula (II):
(R²—B-A-X)ₙ-Z-(X-A-B—R¹)ₘ (II)
wherein Z is a central, multi-arm structural unit; A is a water-soluble, hydrophilic arm; each of B and X is independently a chemical bond or a divalent, low-molecular-weight organic residue having from 1 to 50 carbon atoms; R¹ is a silyl terminal group which is not attached via a polyisocyanate or diisocyanate to the end of the polymer arm; R² is a group which can react with R¹, with the substrate, and/or with itself; and each of m and n is a whole number having a value such that m≧1 and n≧0 and m+n has a value from 3 to 100 with the proviso that when at least one R² residue is an isocyanate residue m+n has a value from 4 to 100 and is equal to the number of arms of Z, and when the coating is derived from a prepolymer-nanoparticle complex, m≧1 and n≧0 and m+n has a value from 3 to a maximum value of 500,000; wherein the coating has a dynamic contact angle hysteresis in water of less than 15°.

2. The coating of claim 1 wherein R¹ is —CR^{a}₂—Si(OR^{b})ᵣ(R^{c})₃₋ᵣ wherein R^{a} is hydrogen or a linear or branched alkyl group having 1 to 6 carbon atoms, OR^{b} is a hydrolyzable group, R^{c} is a linear or branched alkyl group having 1 to 6 carbon atoms; and r is a number from 1 to 3; with the proviso that when the terminal group of R¹ is silyl a terminal group, it is not being bonded via a polyisocyanate to the end of the polymer arm.

3. The coating of claim 1 wherein both the advancing and the receding water contact angles of the hysteresis are less than 65°.

4. The coating of claim 3 wherein both the advancing and the receding water contact angles of the hysteresis are less than 45°.

5. The coating of claim 3 wherein both the advancing and the receding water contact angles of the hysteresis are less than 10°.

6. The coating of claim 3 wherein both the advancing and the receding water contact angles of the hysteresis are less than 6°.

7. The coating of claim 2 wherein OR^{b} is an alkoxyl residue and r is 1-3.

8. The coating of claim 7 wherein the alkoxyl residue is methoxy or ethoxy.

9. The coating of claim 1 wherein the B residue in B—R¹ is selected from the group consisting of a urethane, ester, ether, amine, and urea group.

10. The coating of claim 9 wherein B is a urethane, ester or urea group.

11. The coating of claim 1 wherein R² is a residue selected from the group consisting of isocyanate, (meth)acrylate, oxirane, an alcoholic OH group, a primary or secondary amino group, a thiol group, and a silane group.

12. The coating of claim 1 wherein A is a residue selected from the group consisting of poly-C₂-C₄ alkylene oxides, polyoxazolidones, polyvinyl alcohols, homo- and copolymers that contain at least 50 wt % polymerized-in N-vinylpyrrolidone, homo- and copolymers comprising at least 30 wt % acrylamide and/or methacrylamide; homo- and copolymers comprising at least 30 wt % acrylic acid and/or methacrylic acid.

13. The coating of claim 1 wherein the poly-C₂-C₄ alkylene oxides are polyethylene oxide or ethylene oxide/propylene oxide copolymers.

14. The coating of claim 13 wherein the poly-C₂-C₄ alkylene oxides comprise an ethylene oxide/propylene oxide copolymer having a propylene oxide proportion of 60 wt % or less.

15. The coating of claim 1 wherein the value of m+n is from 3 to 10.

16. The coating of claim 1 wherein the average molecular weight of the star-shaped prepolymer is from 2,000 to 20,000 g/mol.

17. The coating of claim 1 wherein the star-shaped prepolymer comprises least 0.05 wt % Si.

18. The coating of claim 1 further comprising biologically active substances, pigments, dyes, fillers, silicic acid units, nanoparticles, functional organosilanes, biological cells, receptors or receptor-carrying molecules or cells, physically incorporated and/or covalently bonded onto or in the coating.

19. A method of coating a substrate with the coating of claim 1 comprising the steps of: (1) contacting the substrate with a solution of the star-shaped prepolymer and/or a star-shaped prepolymer-nanoparticle complex of claim 1; (2) at least partially cross-linking the prepolymer by reacting the terminal silyl terminal groups wherein the partial cross-linking reaction is carried out previously to, simultaneously with or subsequent to step (1) whereby the prepolymer and/or a star-shaped prepolymer-nanoparticle complex is partially covalently bonded to the substrate.

20. The method of claim 19 wherein the prepolymer and/or a star-shaped prepolymer-nanoparticle complex is further comprised of biologically active substances, pigments, dyes, filler, silicic acid units, nanoparticles, organosilanes, biological cells, receptors or receptor-carrying molecules or cells, or precursors thereof.

21. The method of claim 19 wherein the solution is further comprised of one or more functional organosilanes.

22. The method of claim 21 wherein the organosilane is tetraethoxyorthosilicate (TEOS).

23. The method of claim 19 wherein the solution is further comprised of an acid catalyst.

24. The method of claim 19 wherein the substrate is contacted by dip coating, spin coating, spray method, polishing in, brushing on, painting, rolling, or blade coating.

25. The method of claim 19 wherein the thickness of the coating after the cross-linking reaction is less than 1 mm.

26. The method of claim 19 wherein the thickness is from 1 to 500 nm

27. The method of claim 26 wherein the thickness is from 5 to 50 nm.

28. The method of claim 29 wherein the solution is comprised of a solvent selected from the group consisting of water, alcohols, water/alcohol mixtures, an aprotic solvent, and mixtures thereof.
